(19) United States
(12) Patent Application Publication
(10) Pub. No.: US 2024/0051894 A1
(43) Pub. Date: Feb. 15, 2024

(54) ACIDIFIED NPKSCL FERTILIZER GRANULES FOR FERTIGATION

(71) Applicant: SABIC GLOBAL TECHNOLOGIES B.V., Bergen op Zoom (NL)

(72) Inventors: Mohamed Akasha KHALEEL, Riyadh (SA); Saleh Nafe ALSHAMMARI, Riyadh (SA)

(73) Assignee: SABIC GLOBAL TECHNOLOGIES B.V., Bergen op Zoom (NL)

(21) Appl. No.: 18/259,995

(22) PCT Filed: Dec. 17, 2021
(86) PCT No.: PCT/IB2021/061966

§ 371 Date: Jun. 29, 2023

Related U.S. Application Data
(60) Provisional application No. 63/132,685, filed on Dec. 31, 2020.

(51) Int. Cl. C05G 5/23; C05G 5/12; C05B 17/00; C05G 3/40

(52) U.S. Cl. CPC C05G 5/23; C05G 5/12; C05B 17/00; C05G 3/44

(57) ABSTRACT

Acidic fertilizer granules, methods for producing the same, and methods for their use in fertigation, are disclosed. The acidic fertilizer granule can contain 1 wt. % to 45 wt. % of nitrogen; 1 wt. % to 45 wt. % of phosphorus; 1 wt. % to 45 wt. % of potassium; 0.1 wt. % to 20 wt. % of sulfur; and 1 wt. % to 45 wt. % of chlorine, wherein the granule contains an effective amount of an inorganic acid sufficient to form a solution having a pH of less than 4 when 10 grams of the fertilizer granule(s) is dissolved in 100 ml of water having a pH of 7 before the fertilizer granule(s) is dissolved in the water.

### CROSS REFERENCE TO RELATED PATENT APPLICATIONS

This application claims the benefit of priority to U.S. Provisional Patent Application Ser. No. 63/132,685, filed Dec. 31, 2020, hereby incorporated by reference in its entirety.

### BACKGROUND OF THE INVENTION

### A. Field of the Invention

The invention generally concerns an acidified fertilizer. More specifically, the acidified fertilizer includes an inorganic acid distributed throughout the bulk of a fertilizer granule.

### B. Description of Related Art

Soil nutrients, such as nitrogen, phosphorus, potassium, and sulfur, as well as trace elements such as iron, zinc, copper, chlorine, and magnesium, are useful for achieving thriving agriculture and growth of plants. Upon repeated planting cycles, the quantity of these nutrients in the soil may be depleted, resulting in inhibited plant growth and decreased production. To counter this effect, fertilizers have been developed to help replace the depleted vital nutrients and to create the right balance of nutrients.

Conventionally, fertilizers can be distributed in the soil by the drop-fertilizing method which applies fertilizer granules or powder directly into the soil. By comparison, fertigation, a method widely employed in commercial agriculture and horticulture, applies fertilizer through the irrigation system by dissolving fertilizers directly in the irrigation system. Advantages of fertigation include increased nutrient absorption by plants, accurate placement of nutrients, reduction of fertilizer consumption, reduction of soil erosion, and reduction of energy needed for applying the solid fertilizers. However, most conventional NPK+S+Cl (nitrogen-phosphorus-potassium-sulfur- and chloride) fertilizers do not fully dissolve in irrigation water with high pH values (pH>7.5) and/or more than 50 ppm calcium content. The phosphorus of the fertilizer can react with the calcium in the water to form an insoluble calcium phosphate complex under high pH conditions. This reduced solubility can result in uneven distribution of the fertilizer in the water. Further, the formation of insoluble calcium phosphate complexes can result in particulate buildup in the irrigation system, which can lead to clogging and ultimately reduced effectiveness or failure of the system to deliver the water to the soil or plants.

Several methods have been developed to improve the solubility of conventional fertilizers in high-pH irrigation water. U.S. Publication No. 2016/0073578 A1 discloses a method for fertigation that includes adding an acidic fertilizer-dissolving agent, including inorganic acids, into water, and then dissolving fertilizer in the water. However, this method requires a step of mixing the water with acid, which may increase the operational cost. Furthermore, direct handling of concentrated inorganic acid including sulfuric acid, hydrochloric acid, nitric acid, or phosphoric acid, can increase safety concerns. Moreover, the reaction of the inorganic acid with the plant nutrient in irrigation water may result in the need for re-determination of the final nutrient ratios in the fertigation solution, increasing the operational cost and time required to prepare a proper fertigation solution.

PCT application No. WO 2018/042312, Japanese Publication No. 2002/316888A, and CA 2995400 each disclose granular fertilizer compositions that include a fertilizer core and an outer coating that contains an inorganic acid. However, high concentrations of inorganic acid on the outer surface of the granular fertilizer can result in absorption of atmospheric water, can increase the safety concerns of handling these granules, and can increase the cost and complexity of keeping these fertilizer granules dry when they are in storage.

Application CN105949010A discloses fertilizers prepared from humic acid, urea, monoammonium phosphate, potassium chloride, manganous sulfate, copper sulfate, borax, sea-foam stone powder, hydrochloric acid, and water. The hydrochloric acid is used to treat the humic acid to form more dissolvable salts from the calcium humate and magnesium salts in humic acid. The fertilizer contained 2 to 6 parts of a hydrochloric acid solution that contained a preferred mass percentage concentration of between 18% and 20%.

Overall, while fertigation compositions exist, the need for improvements in this field persists in light of at least the aforementioned drawbacks for the currently available methods.

### SUMMARY OF THE INVENTION

A solution to at least some of the above-mentioned problems associated with currently available fertilizer compositions used for fertigation has been discovered. The solution resides in providing an acidic fertilizer granule containing nitrogen, phosphorus, potassium, sulfur, and chlorine, wherein the acidic fertilizer granule contains an inorganic acid that is distributed throughout the fertilizer granule. These acidic fertilizers improve the solubility of the fertilizer in irrigation water with a high pH value by preventing or reducing the reaction between calcium in the irrigation water and the phosphorus in the fertilizer. In some aspects, the fertilizers herein are 100% water soluble. The fertilizers can also prevent the formation of insoluble calcium phosphate complex crystals in the water. Additionally, the fertilizer granules of the present invention avoid or reduce direct handling of concentrated inorganic acid by having the inorganic acid distributed throughout the granules. In some instances, the inorganic acid is not present on the surface of the granules. Furthermore, the acidic fertilizer granules of the present invention reduce the tendency of the fertilizers to absorb atmospheric water, lowering the cost for and complexity in keeping the granules dry during storage. The acidified fertilizer granules can increase the nutrient availability from the fertilizers when used in fertigation, as a broadcast dry fertilizer, and/or in soil applications using the dry fertilizer. Therefore, the fertilizer granules of the present invention provide several technical advantages over the currently available fertilizer compositions used for fertigation.

Some embodiments of the invention are directed to an acidic fertilizer granule. The acidic fertilizer granule can contain nitrogen, phosphorus, potassium, sulfur, and chlorine. In some aspects, the fertilizer granule can contain 1 wt. % to 45 wt. % of nitrogen, 1 wt. % to 45 wt. % of phosphorus, 1 wt. % to 45 wt. % of potassium, 0.1 wt. % to 20 wt. % of sulfur, and 1 wt. % to 45 wt. % of chlorine. The fertilizer granule can contain an inorganic acid. The inorganic acid can provide at least a portion of the sulfur and/or chlorine in the acidic fertilizer granule. In some aspects, the inorganic acid can provide at least a portion of the sulfur in the acidic fertilizer granule. In some aspects, the inorganic acid can be distributed throughout the granule. In some aspects, the fertilizer granule can contain 2 wt. % or more, preferably 2 wt. % to 40 wt. %, more preferably 3 wt. % to 35 wt. %, still more preferably 4 wt. % to 32 wt. % of the inorganic acid. In certain aspects, the fertilizer granule can contain 8 wt. % or more of the inorganic acid. In certain aspects, the fertilizer granule can contain 8 wt. % to 32 wt. % of the inorganic acid. The inorganic acid can contain sulfuric acid, hydrochloric acid, nitric acid, phosphoric acid, or any combinations thereof. In some aspects, the inorganic acid contains sulfuric acid. In certain aspects, the fertilizer granule can contain 2 to 40 wt. % of nitrogen, and at least a portion of nitrogen can be present as ammonium. In certain aspects, the fertilizer granule can contain 2 to 40 wt. % of phosphorus, and at least a portion of phosphorus can be present as phosphate. In certain aspects, the fertilizer granule can contain 2 to 40 wt. % of potassium, and at least a portion of potassium can be present as potassium salt, preferably potassium chloride. In certain aspects, the fertilizer granule can contain 2 to 40 wt. % of chlorine, and at least a portion of chlorine can be present as chloride, preferably potassium chloride and/or hydrochloric acid. In certain aspects, the fertilizer granule can contain 5 to 15 wt. % of sulfur and at least a portion of sulfur is present as sulfate. In some aspects, at least a portion of the sulfate can be present as sulfuric acid. In certain aspects, the fertilizer granule can contain i) 2 to 40 wt. % of nitrogen, and at least a portion of nitrogen is present as ammonium, ii) 2 to 40 wt. % of phosphorus, at least a portion of phosphorus is present as phosphate, iii) 2 to 40 wt. % of potassium, and at least a portion of potassium is present as potassium salt, preferably potassium chloride, iv) 2 to 40 wt. % of chlorine, and at least a portion of chlorine is present as chloride, preferably potassium chloride and/or hydrochloric acid, v) 5 to 15 wt. % of sulfur and at least a portion of sulfur is present as sulfate, or any combinations thereof. In certain aspects, the fertilizer granule can contain i) 17 to 21 wt. % of nitrogen, ii) 17 to 21 wt. % of phosphorus, iii) 17 to 21 wt. % of potassium, iv) 2 to 5 wt. % of sulfur, v) 13 to 19 wt. % of chlorine, or any combinations thereof. In certain aspects, the fertilizer granule can contain 8 to 12 wt. % of sulfuric acid. In certain aspects, the fertilizer granule can have a moisture content of less than 2 wt. %, or less than 1 wt. %, measured when the granule is at 50° C.

In some instances, the fertilizer granule can have a N:P:K:S:Cl (nitrogen:phosphorus:potassium:sulfur:chlorine) ratio (NPKSCl grade or NPK+S+Cl grade) by weight of about 7:19:12:15:11, about 7:19:12:10:11, about 9:25:7:8:6, about 10:5:10:10:9, about 13:13:13:11:12, about 10:19:10:10:9, about 10:10:20:13:18, about 8:15:8:9:7, about 11:6:17:12:15, about 8:8:23:14:21, about 10:10:10:10:9, about 8:5:26:15:23, about 6:16:6:8:5, about 6:29:6:8:5, about 10:5:15:12:14, about 11.5:11.5:11.5:9.8:10.4, about 18:9:9:9:8, about 8:26:8:9:7, about 12:12:12:10:11, about 19:19:19:3.5:15, or about 12:12:4:8:4. In some non-limiting instances, the term “about” is defined to be within 10%, 9%, 8%, 7%, 6%, 5%, 4%, 3%, 2%, 1%, or 0.5%.

In some aspects, the fertilizer granule can further contain one or more additional ingredients. Additional ingredients that can be contained in the granule include a preservative, insecticide, fungicide, fragrance, fertilizer, plant growth agent, nutrient, trace element, plant protection agent, filler, micronutrients, secondary nutrients, flow promotors, binders, pH adjusters or buffers, etc., or any combinations thereof. A micronutrient can be a botanically acceptable form of an inorganic or organometallic compound such as boron, copper, iron, chloride, manganese, molybdenum, nickel, or zinc. A secondary nutrient is a substance that can deliver calcium, magnesium, and/or sulfur to a plant. In some instances, the granule does not contain one or more of the additional ingredients. The additional ingredients can be combined into the granule when the plant nutrient(s) is mixed to form a mixture. The granule can contain any amount of additional ingredients, such as 0.001 wt. % to 50 wt. %, 0.001 wt. % to 40 wt. %, 0.001 wt. % to 30 wt. %, 0.001 wt. % to 20 wt. %, 0.01 wt. % to 10 wt. %, 0.01 wt. % to 9 wt. %, 0.01 wt. % to 8 wt. %, 0.01 wt. % to 7 wt. %, or any range or value therein. In some instances, the granule can contain 0.001, 0.002, 0.003, 0.004, 0.005, 0.006, 0.007, 0.008, 0.009, 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1, 2, 3, 4, 5, 6, 7, 8, 9, 10, 15, 20, 25, 30, 35, or 40 wt. % of additional ingredients.

In some instances, the fertilizer granule may further include a coating that contains one or more of water, one or more solubilizing agent(s), one or more binder(s), and/or one or more anticaking agent(s). In some instances, the fertilizer granule does not contain a coating. In some instances, the coating does not contain an inorganic acid. The coating can, in some instances, contain one or more binder(s) and/or one or more anticaking agent(s). In some instances, the water contained in the coating can be less than 5% by weight of the coating. Such a coating with reduced water or moisture content can be considered a dried or dry coating. In some instances, the water content is 4 wt. %, 3 wt. %, 2 wt. %, 1 wt. %, or less, compared to the weight of the coating. The solubilizing agent can be Na₂CO₃, NaOH, KOH, Ca(OH)₂, Mg(OH)₂, and/or K₂CO₃. The binder can be triple super phosphate (TSP), guar gum, waxes such as paraffin wax, oils such as linseed oils and paraffin oils, flours and starches such as bleached wheat flour, gelatins, and/or polymers. The anticaking agent can be any anticaking agent known, such as surfactants, amines, liquid carriers such as oil and/or water, and/or a URESOFT® product supplied by Kao Chemicals, such as URESOFT®-125, or any combinations thereof. In embodiments of the invention, the coating can contain the components therein at any concentration, ratio, percent by weight, percent by volume, etc.

Also disclosed in the context of the present invention are fertilizer blends or compounded fertilizers containing the fertilizer granule and an additional fertilizer. The additional fertilizer can be, but is not limited to, nitrogen and phosphorus (NP), phosphorus and potassium (PK), nitrogen, phosphorus, and potassium (NPK), diammonium phosphate (DAP), monoammonium phosphate (MAP), single superphosphate (SSP), triple super-phosphate (TSP), or any combinations thereof. In one aspect, the additional fertilizer can include an inorganic acid. In other aspects, however, the additional fertilizer does not include an inorganic acid.

In some aspects, the acidic fertilizer granule can contain an effective amount of the inorganic acid sufficient to form a solution having a pH of less than 4, when 10 grams of the acidic fertilizer granule(s) is dissolved in 100 ml of water having a pH of 7 before the acidic fertilizer granule(s) is dissolved in the water. In some instances, the granule can include an effective amount of the inorganic acid sufficient to form a solution having a pH of less than 4, less than 3.5, less than 3, less than 2.5, less than 2, less than 1.5, or less than 1, when 10 grams of the fertilizer granule(s) is dissolved in 100 ml of water having a pH of 7 to 10, before the fertilizer granule(s) is dissolved in the water. In some aspects, 50 wt. % or higher, 60 wt. % or higher, 70 wt. % or higher, 80 wt. % or higher, 90 wt. % or higher, or 95 wt. % or higher, of the fertilizer granule can dissolve in 1 L of water at a pH 7, under stirring at a rate 90 rpm to 110 rpm, at an ambient temperature, within 15 minutes of adding 100 mg of the fertilizer granules to the water. In some instances, the granule can include an effective amount of the inorganic acid sufficient to form the solution when at most 9 grams, at most 8 grams, at most 7 grams, at most 6 grams, at most 5 grams, at most 4 grams, at most 3 grams, at most 2 grams, or at most 1 gram of the fertilizer granule(s) is dissolved. In some instances, the fertilizer granule(s) is dissolved in at least 150 ml, at least 200 ml, at least 300 ml, at least 400 ml, at least 500 ml, at least 600 ml, at least 700 ml, at least 800 ml, at least 900 ml, at least 1000 ml, at least 2000 ml, or at least 3000 ml, etc. of water. In some instances the water has a pH of greater than 7.5, greater than 8.0, greater than 8.5, greater than 9.0, greater than 9.5, greater than 10.0, greater than 10.5, greater than 11.0, or greater than 11.5, etc. In some aspects, the water can contain at least 50 ppm calcium (Ca²⁺) and the granule contains an effective amount of the inorganic acid sufficient to prevent the formation of calcium phosphate from the phosphorus in the plant nutrient and the calcium in the water. In some instances, the water contains at least 100 ppm, at least 150 ppm, at least 200 ppm, at least 250 ppm, at least 300 ppm, at least 350 ppm, at least 400 ppm, at least 450 ppm, at least 500 ppm, at least 550 ppm, at least 600 ppm, at least 650 ppm, at least 700 ppm, at least 750 ppm, at least 800 ppm, at least 850 ppm, at least 900 ppm, at least 950 ppm, at least 1000 ppm, at least 1500 ppm, at least 2000 ppm, at least 2500 ppm, at least 3000 ppm, at least 3500 ppm, or at least 4500 ppm, etc. calcium.

One aspect is directed to a method for making an acidic fertilizer granule described herein. The method can include adding an inorganic acid to a mixture to form an acidified mixture, wherein the acidified mixture contains nitrogen, phosphorus, potassium, sulfur, and chlorine; and granulating the acidified mixture. In certain aspects, the method can include reacting phosphoric acid with ammonia to form a nitrogen-phosphorus paste, and adding the nitrogen-phosphorus paste to a material containing potassium to form a nitrogen-phosphorus-potassium paste and granulating the nitrogen-phosphorus-potassium paste, wherein an inorganic acid, such as sulfuric acid, is added to the nitrogen-phosphorus paste, and/or nitrogen-phosphorus-potassium paste. In some aspects, the inorganic acid can be added before, after, and/or during the granulation of the nitrogen-phosphorus-potassium paste. In some aspects, the material containing potassium can further contain chloride. In certain aspects, material containing potassium can further contain nitrogen and/or phosphorus. In certain aspects, the acidified mixture can contain acidified nitrogen-phosphorus-potassium-sulfur-chlorine paste.

One aspect is directed to a method for fertigation. In some aspects, the method for fertigation may include combining an acidic fertilizer granule described herein, and/or a fertilizer blend containing an acidic fertilizer granule described herein, with water to form a fertigation solution having a pH less than 4, optionally combining the fertigation solution with additional water to form a fertilizer solution, and applying the fertigation solution or the fertilizer solution to a crop. In some aspects of the invention, combining the fertilizer granule to the water decreases the pH of the water from a pH of 4 or greater to a pH of less than 4, less than 3.5, less than 3, less than 2.5, less than 2, less than 1.5, or less than 1. In some instances, the combining the fertilizer granule to the water decreases the pH of the water to a pH of less than 4 from a pH of 6.5 or greater, 7.0 or greater, 7.5 or greater, 8.0 or greater, 8.5 or greater, 9.0 or greater, 9.5 or greater, 10.0 or greater, 10.5 or greater, 11.0 or greater, or 11.5 or greater, or 6.5 to 11.5, or greater than 7.0 to 10, or greater than 7.0 to 9, or greater than 7.0 to 8.5. In one aspect, the applying step can include applying the fertigation solution or the fertilization solution to at least one of a soil, an organism, a crop, a liquid carrier, a liquid solvent, or any combinations thereof. Application of the fertigation solution or the fertilization solution can promote plant growth and/or plant health.

In some aspects, the water used to form the fertigation solution or fertilizer solution can contain at least 50 ppm of calcium (Ca²⁺). In some instances, the water comprises more than 100 ppm of calcium (Ca²⁺), more than 200 ppm of calcium, more than 300 ppm of calcium, more than 400 ppm of calcium, more than 500 ppm of calcium, more than 600 ppm of calcium, more than 700 ppm of calcium, more than 800 ppm of calcium, more than 900 ppm of calcium, more than 1,000 ppm of calcium, more than 1,500 ppm of calcium, more than 2,000 ppm of calcium, more than 2,500 ppm of calcium, more than 3,000 ppm of calcium, more than 3,500 ppm of calcium, or more than 4,000 ppm of calcium. In some aspects, the water comprises at least 50 ppm of Ca²⁺ to 1000 ppm of Ca²⁺, or at least 50 ppm Ca²⁺ to 500 ppm of Ca²⁺, or at least 50 ppm of Ca²⁺ to 250 ppm Ca²⁺, or at least 50 ppm Ca²⁺ to 150 Ca²⁺.

Also disclosed are the following Aspects 1 to 20 of the present invention.

Aspect 1 is an acidic fertilizer granule comprising: 1 wt. % to 45 wt. % of nitrogen; 1 wt. % to 45 wt. % of phosphorus; 1 wt. % to 45 wt. % of potassium; 0.1 wt. % to 20 wt. % of sulfur; and 1 wt. % to 45 wt. % of chlorine, wherein the granule comprises an effective amount of an inorganic acid sufficient to form a solution having a pH of less than 4 when 10 grams of the fertilizer granule(s) is dissolved in 100 ml of water having a pH of 7 before the fertilizer granule(s) is dissolved in the water.

Aspect 2 is the fertilizer granule of Aspect 1, wherein the inorganic acid is distributed throughout the granule.

Aspect 3 is the fertilizer granule of any one of Aspects 1 to 2, wherein the amount of the inorganic acid in the granule is sufficient to form a solution having a pH of less than 3, preferably less than 2, when 10 grams of the fertilizer granule(s) is dissolved in 100 ml of water having a pH of 7 before the fertilizer granule is dissolved in the water.

Aspect 4 is the fertilizer granule of any one of Aspects 1 to 3, comprising 2 wt. % or more, preferably 2 wt. % to 40 wt. %, more preferably 3 wt. % to 35 wt. %, still more preferably 4 wt. % to 32 wt. % of the inorganic acid.

Aspect 5 is the fertilizer granule of any one of Aspects 1 to 4, comprising 8 wt. % or more of the inorganic acid.

Aspect 6 is the fertilizer granule of any one of Aspects 1 to 5, wherein the inorganic acid comprises sulfuric acid, hydrochloric acid, nitric acid, or any combinations thereof.

Aspect 7 is the fertilizer granule of Aspect 6, wherein the inorganic acid comprises sulfuric acid.

Aspect 8 is the fertilizer granule of any one of Aspects 1 to 7, further comprising a secondary nutrient and/or a micronutrient.

Aspect 9 is the fertilizer granule of any one of Aspects 1 to 8, comprising 2 to 40 wt. % of nitrogen, and at least a portion of nitrogen is present as ammonium.

Aspect 10 is the fertilizer granule of any one of Aspects 1 to 9, comprising 2 to 40 wt. % of phosphorus, and at least a portion of phosphorus is present as phosphate.

Aspect 11 is the fertilizer granule of any one of Aspects 1 to 10, comprising 2 to 40 wt. % of potassium, and at least a portion of potassium is present as potassium salt, preferably potassium chloride.

Aspect 12 is the fertilizer granule of any one of Aspects 1 to 11, comprising 2 to 40 wt. % of chlorine, and at least a portion of chlorine is present as chloride, preferably potassium chloride and/or hydrochloric acid.

Aspect 13 is the fertilizer granule of any one of Aspects 1 to 12, comprising 0.5 to 15 wt. % of sulfur and at least a portion of sulfur is present as sulfate.

Aspect 14 is the fertilizer granule of any one of Aspects 1 to 13, comprising 17 to 21 wt. % of nitrogen, 17 to 21 wt. % of phosphorus, 17 to 21 wt. % of potassium, 2 to 5 wt. % of sulfur, and 13 to 19 wt. % of chlorine.

Aspect 15 is the fertilizer granule of any one of Aspects 1 to 14, comprising 8 to 12 wt. % of sulfuric acid.

Aspect 16 is the fertilizer granule of any one of Aspects 1 to 15, having moisture content of less than 2 wt. %, or less than 1 wt. %, measured at 50° C.

Aspect 17 is the fertilizer granule of any one of Aspects 1 to 16, comprised in a fertilizer blend comprising the fertilizer granule and an additional fertilizer.

Aspect 18 is a method of making the acidic fertilizer granule of any one of Aspects 1 to 17, comprising: adding an inorganic acid to a mixture to form an acidified mixture, wherein the acidified mixture comprises nitrogen, phosphorus, potassium, sulfur, and chlorine; and granulating the acidified mixture.

Aspect 19 is a method of fertigation, the method comprising: combining the acidic fertilizer granule of any one of Aspects 1 to 17 with water to form a fertigation solution having a pH less than 4; optionally combining the fertigation solution with additional water to form a fertilizer solution; and applying the fertigation solution and/or the fertilizer solution to a soil and/or a crop.

Aspect 20 is the method of Aspect 19, wherein combining the acidic fertilizer granule with the water decreases the pH of the water from a pH of greater than 4 to a pH of less than 4.

The following includes definitions of various terms and phrases used throughout this specification.

The term “fertilizer” is defined as a material applied to soils or to plant tissues to supply one or more plant nutrients essential or beneficial to the growth of plants and/or stimulants or enhancers to increase or enhance plant growth. Non-limiting examples of fertilizers include materials having one or more of urea, ammonium nitrate, calcium ammonium nitrate, one or more superphosphates, binary NP fertilizers, binary NK fertilizers, binary PK fertilizers, NPK fertilizers, molybdenum, zinc, copper, boron, cobalt, and/or iron. In some aspects, fertilizers include agents that enhance plant growth and/or enhance the ability for a plant to receive the benefit of a fertilizer, such as, but not limited to biostimulants, urease inhibitors, and nitrification inhibitors. In some particular instances, the fertilizer is urea, such as urea granules.

The terms “about,” “approximately,” and “substantially” are defined as being close to, as understood by one of ordinary skill in the art. In one non-limiting instance, the terms are defined to be within 10%, preferably within 5%, more preferably within 1%, and most preferably within 0.5%.

The terms “wt. %,” “vol. %,” or “mol. %” refers to a weight, volume, or molar percentage of a component, respectively, based on the total weight, the total volume, or the total moles of material that includes the component. In a non-limiting example, 10 grams of a component in 100 grams of the material that includes the component is 10 wt. % of component.

The use of the words “a” or “an” when used in conjunction with any of the terms “comprising,” “including,” “containing,” or “having” in the claims or the specification may mean “one,” but it is also consistent with the meaning of “one or more,” “at least one,” and “one or more than one.”

The phrase “and/or” can include “and” or “or.” To illustrate, A, B, and/or C can include: A alone, B alone, C alone, a combination of A and B, a combination of A and C, a combination of B and C, or a combination of A, B, and C.

The words “comprising” (and any form of comprising, such as “comprise” and “comprises”), “having” (and any form of having, such as “have” and “has”), “including” (and any form of including, such as “includes” and “include”), or “containing” (and any form of containing, such as “contains” and “contain”) are inclusive or open-ended and do not exclude additional, unrecited elements or method steps.

The compositions and process of the present invention can “comprise,” “consist essentially of,” or “consist of” particular ingredients, components, compositions, etc., disclosed throughout the specification. With respect to the transitional phase “consisting essentially of,” in one non-limiting aspect, a basic and novel characteristic of the acidic fertilizer of the present invention is that the acidic fertilizer contains nitrogen, phosphorus, potassium, sulfur, and chlorine, wherein an inorganic acid is distributed throughout the acidic fertilizer granule.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes, combinations, and modifications within the spirit and scope of the invention will become apparent to those skilled in the art from this detailed description.

### BRIEF DESCRIPTION OF THE DRAWINGS

Advantages of the present invention may become apparent to those skilled in the art with the benefit of the following non-limiting detailed description and upon reference to the accompanying non-limiting drawings. The drawings may not be to scale.

FIG. 1 cross-sectional view of an acidic fertilizer granule according to an example of the present invention.

FIG. 2 cross-sectional view of a coated acidic fertilizer granule according to an example of the present invention.

FIG. 3 is a schematic diagram depicting an exemplary method of producing a non-limiting embodiment of an acidic fertilizer granule of the present invention.

FIG. 4 is a schematic diagram depicting an exemplary method of using non-limiting embodiments of the acidic fertilizer granules of the present invention in fertigation.

### DETAILED DESCRIPTION OF THE INVENTION

The acidic fertilizer granules of the present invention provide an elegant solution to at least some of the problems associated with conventional fertilizers used in fertigation. Notably, the acidic fertilizer granules include an inorganic acid that is distributed throughout the acidic fertilizer granule, so that the granule can be dissolved in calcium-containing irrigation water that has a high pH value and can prevent the formation of insoluble calcium phosphate complex crystals. Furthermore, the acidic fertilizer granules prevent the safety risks of handling fertilizer granules having highly concentrated inorganic acid on the surfaces thereof. Moreover, the acidic fertilizer granules may be capable of reducing storage cost and complexity as compared to acidified fertilizer with an acidic coating. Also, by distributing the inorganic acid throughout the bulk of the granule instead of only on its surface (e.g., surface coating), absorption of atmospheric water can be reduced. The acidified fertilizer granules can increase the nutrient availability from the fertilizers when used in fertigation, as a broadcast dry fertilizer, and/or in soil applications using the dry fertilizer. In some aspects, the fertilizers herein are 100% water soluble.

These and other non-limiting aspects of the present invention are discussed in further detail in the following sections with reference to the Figures.

### A. Acidic Fertilizer

1. Acidic Fertilizer Granule

In some embodiments, the acidic fertilizer granule of the present invention can contain i) 1 wt. % to 45 wt. %, or at least any one of, equal to any one of, at most any one of, or between any two of 1, 2, 4, 6, 8, 10, 12, 14, 16, 18, 20, 22, 24, 26, 28, 30, 32, 34, 36, 38, 40, 42, 44, and 45 wt. % of nitrogen, ii) 1 wt. % to 45 wt. %, or at least any one of, equal to any one of, at most any one of, or between any two of 1, 2, 4, 6, 8, 10, 12, 14, 16, 18, 20, 22, 24, 26, 28, 30, 32, 34, 36, 38, 40, 42, 44, and 45 wt. % of phosphorus, iii) 1 wt. % to 45 wt. %, or at least any one of, equal to any one of, at most any one of, or between any two of 1, 2, 4, 6, 8, 10, 12, 14, 16, 18, 20, 22, 24, 26, 28, 30, 32, 34, 36, 38, 40, 42, 44, and 45 wt. % of potassium, iv) 0.1 wt. % to 20 wt. %, or at least any one of, equal to any one of, at most any one of, or between any two of 0.1, 0.5, 1, 2, 3, 4, 5, 6, 7, 8, 9, 10, 11, 12, 13, 14, 15, 16, 17, 18, 19, and 20 wt. % of sulfur and v) 1 wt. % to 45 wt. %, or at least any one of, equal to any one of, at most any one of, or between any two of 1, 2, 4, 6, 8, 10, 12, 14, 16, 18, 20, 22, 24, 26, 28, 30, 32, 34, 36, 38, 40, 42, 44, and 45 wt. % of chlorine. The fertilizer granule can contain an effective amount of an inorganic acid sufficient to form a solution having a pH of less than 4, less than 3.5, less than 3, less than 2.5, less than 2, less than 1.5, or less than 1, when 10 grams of the acidic fertilizer granule(s) is dissolved in 100 ml of water having a pH of 7 before the acidic fertilizer granule(s) is dissolved in the water. In some instances, the inorganic acid content of the granule can be sufficient to form a solution having a pH of less than 4, less than 3.5, less than 3, less than 2.5, less than 2, less than 1.5, or less than 1, when 10 grams of the acidic fertilizer granule(s) is dissolved in 100 ml of water having a pH of 7 to 10 before the acidic fertilizer granule(s) is dissolved in the water. In some aspects, the fertilizer granule can contain 2 wt. % to 40 wt. %, or at least any one of, equal to any one of, at most any one of, or between any two of 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, and 40 wt. % of the inorganic acid. The inorganic acid can be sulfuric acid, hydrochloric acid, nitric acid, or any combinations thereof. In certain aspects, the inorganic acid can be sulfuric acid, and provide at least a portion of the sulfur in the granule. In some aspects, at least a portion of the nitrogen in the fertilizer granule can be sourced as and/or present as ammonium. In certain aspects, at least a portion of the ammonium can be present as diammonium phosphate (DAP), and/or monoammonium phosphate (MAP). In some aspects, at least a portion of the phosphorus in the fertilizer granule can be sourced as and/or present as phosphate. In certain aspects, at least a portion of the phosphate can be present as diammonium phosphate (DAP), monoammonium phosphate (MAP), single superphosphate (SSP), triple super-phosphate (TSP), or any combinations thereof. In some aspects, at least a portion of the potassium in the fertilizer granule can be sourced as and/or present as a potassium salt, such as potassium chloride. In some aspects, at least a portion of the chlorine in the fertilizer granule can be sourced as and/or present as a chloride, such as potassium chloride and/or hydrochloric acid. In some aspects, at least a portion of the sulfur in the fertilizer granule can be sourced as and/or present as a sulfate. In some aspects, at least a portion of the sulfate in the fertilizer granule can be present as sulfuric acid.

The total combined weight percent of nitrogen, phosphorus, potassium, sulfur, and chlorine content of the fertilizer granule can be at least 20%, 25%, 30%, 35%, 40%, 45%, 50%, 60%, 65%, 70%, 75%, 80%, 85%, 90%, 95%, 99%, 100%, or any range or concentration derivable therein. In certain aspects, the acidic fertilizer granule can contain one or more additional ingredients. Additional ingredients that can be contained in the granule include a preservative, insecticide, fungicide, fragrance, fertilizer, plant growth agent, nutrient, trace element, plant protection agent, filler, micronutrients, secondary nutrients, flow promotors, binders, pH adjusters or buffers, anticaking agents, water, pigments, etc., or any combinations thereof. Non-limiting examples of anticaking agents include surfactants, amines, liquid carriers such as oil and/or water, and/or a URESOFT® product supplied by Kao Chemicals (Kao Corporation, Japan), such as URESOFT®-125. In some aspects, an additional ingredient is not used.

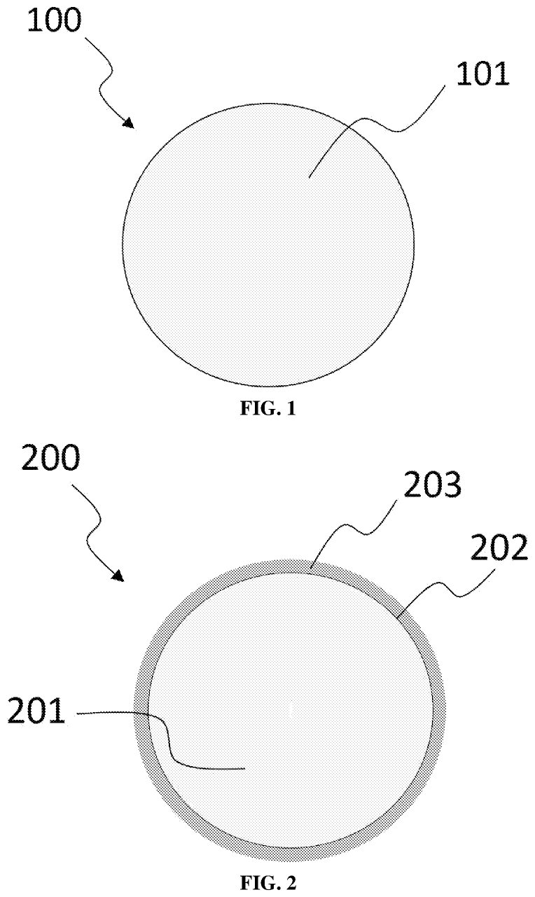

Referring to FIG. 1, a fertilizer granule 100 according to one example of the present invention is shown. The fertilizer granule 100 can contain nitrogen, phosphorus, potassium, chlorine, and sulfur distributed throughout the bulk (101) of the granule. The acidic fertilizer granule 100 can optionally contain one or more additional ingredients. Nitrogen, phosphorus, potassium, chlorine, and sulfur can be distributed throughout the bulk (101) of the granule homogeneously or heterogeneously.

The terms bulk, matrix, and network can be used interchangeably in this specification when referencing the matrix of the acidic fertilizer granule. The inorganic acid can be evenly distributed throughout the bulk of the granule by: (1) adding a solution of inorganic acid to particles of the plant material to form a paste; (2) forming granules from the paste; and optionally (3) drying the granules. Alternatively, particles of plant nutrient materials and particles of inorganic acid can be mixed together to form a solid mixture. Granules can be formed from the solid mixture (e.g., by compaction); by having more (volume %) of the solid plant nutrient particles relative to the inorganic acid particles, the plant nutrient particles can make up the bulk of the granules, and the inorganic acid particles can be evenly distributed throughout the bulk.

2. Coating of the Acidic Fertilizer Granule

In some aspects, the acidic fertilizer granule can include a coating that contains one or more of water, one or more solubilizing agent(s), one or more binders, and/or one or more anticaking and/or coloring (pigment) agents. In some instances, the water contained in the coating can be less than 5% by weight of the coating and be considered a dried or dry coating. In some instances, the water content in the coating is less than 4 wt. %, 3 wt. %, 2 wt. %, or 1 wt. % of the weight of the coating.

In some aspects, the coating of the acidic fertilizer granule does not contain the inorganic acid. In some aspects, the coating can contain one or more pigments.

It is contemplated that the acidic fertilizer granule of the present invention can contain a coating in any amount, volume, thickness, coverage of the fertilizer granule surface, etc. In some instances, 0.001 wt. % to 10 wt. %, or at least any one of, equal to any one of, at most any one of, or between any two of 0.001, 0.01, 0.1, 0.5, 1, 2, 3, 4, 5, 6, 7, 8, 9, and 10 wt. % of the coated acidic fertilizer granule can be comprised of the coating.

In some aspects, at least a portion of the acidic fertilizer granule's surface can be in direct contact with the coating. In some instances, the coating is not dispersed throughout the fertilizer granule. In some instances, the coating forms a shell at least partially coating the granule. The coating can coat at least 55%, 60%, 65%, 70%, 75%, 80%, 85%, 90%, 95%, or 100% of an outer surface of the granule. The granule can be coated by the coating so that dissolution of water into the core is decreased as compared to the granule without the coating. In some instances, the coating has a mean average thickness of 2 to 70 μm, 2 to 20 μm, 20 to 50 μm, or 10 to 40 μm, or any range or thickness therein.

Referring to FIG. 2, a coated acidic fertilizer granule 200 according to an example of the present invention is shown. The coated acidic fertilizer granule 200 can contain a coating 203 over the fertilizer granule 201. Although the coating 203 is shown to coat an entire outer surface 202 of the granule 201, a coated acidic fertilizer granule having a coating partially covering/coating an outer surface of the granule can readily be made.

3. Blended or Compounded Fertilizers

The acidic fertilizer of the present invention can be included with other fertilizers in a fertilizer composition. In some instances, the acidic fertilizer is contained in a blended fertilizer composition or a compounded fertilizer. Additional fertilizers can be chosen based on the particular needs of certain types of soil, climate, or other growing conditions to maximize the efficacy of the blended composition in enhancing plant growth and crop yield. The acidic fertilizer herein can be blended with other fertilizer at any concentration. In some instances, the desired concentration is sufficient to meet the required nutrient or micronutrient content in the blend. By way of example, a blended fertilizer composition of the present invention can be formulated into a quick release fertilizer. Alternatively, the blended fertilizer composition can be formulated into a slow-release fertilizer. In some instances, the blended fertilizer composition is formulated into a specialty fertilizer.

### B. Method of Making the Acidic Fertilizer Granule

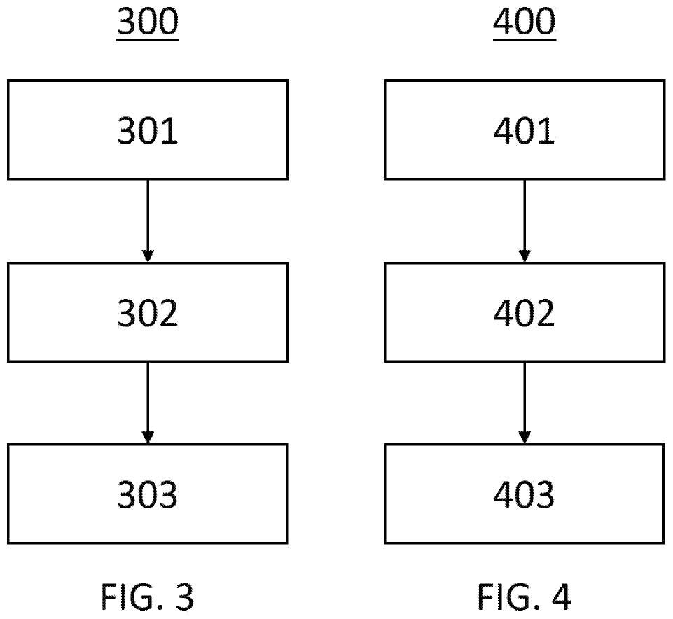

With reference to FIG. 3, a non-limiting method (300) of making the acidic fertilizer granule can include adding an inorganic acid to a mixture to form an acidified mixture, wherein the acidified mixture contains nitrogen, phosphorus, potassium, sulfur, and chlorine; and granulating the acidified mixture to form a wet granulated mixture (301).

In certain aspects, the method can include reacting phosphoric acid with ammonia to form a nitrogen-phosphorus paste, and adding the nitrogen-phosphorus paste to a material containing potassium to form a nitrogen-phosphorus-potassium paste and granulating the nitrogen-phosphorus-potassium paste to form the wet granulated mixture (301), wherein an inorganic acid, such as sulfuric acid, is added to the nitrogen-phosphorus paste, and/or nitrogen-phosphorus-potassium paste. The sulfur and chlorine can be independently provided to the granule from the inorganic acid, material containing potassium, and/or another source. The sulfur and chlorine can be added before, during, and/or after formation of the paste. In some aspects, the inorganic acid can be added before, after, and/or during the granulation of the nitrogen-phosphorus-potassium paste. In some aspects, the material containing potassium can contain potassium chloride. In certain aspects, material containing potassium can further contain nitrogen and/or phosphorus. In some aspects, the phosphoric acid and ammonia can be reacted in a reactor to form the nitrogen-phosphorus paste, and the nitrogen-phosphorus paste can be added to the material containing potassium in a granulator to form the nitrogen-phosphorus-potassium paste, and the nitrogen-phosphorus-potassium paste can be granulated in the granulator to form the wet granulated material. The sulfur and chlorine can be independently provided to the granules from the inorganic acid, material containing potassium, and/or another source. The sulfur and chlorine can be added before, during, and/or after formation of the paste. In certain aspects, the inorganic acid can be added to the reactor before, after, and/or during the reaction between phosphoric acid and ammonia. In some aspects, as an alternative to, or in addition to adding the inorganic acid in the reactor, the inorganic acid can be added in the granulator before, after, and/or during the granulation of the nitrogen-phosphorus-potassium paste.

In some instances, the inorganic acid added in the reactor and/or the granulator can be concentrated sulfuric acid, preferably 98 wt. % sulfuric acid. The inorganic acid added in the reactor and/or the granulator may be in particulate form and/or dissolved in a solution.

In some aspects, the reactor for reacting phosphoric acid with ammonia can include a pre-neutralizer unit or T-Tube reactor. In some aspects, adding the inorganic acid solution and/or particulate inorganic acid to the paste (e.g. nitrogen-phosphorus paste and/or nitrogen-phosphorus-potassium paste) can include mixing the inorganic acid with the paste. Mixing can be performed by processes such as stirring, vortexing, homogenizing, shaking, pouring, etc. In some aspects, the mixing can facilitate the inorganic acid being homogeneously or substantially homogeneously distributed throughout the acidic fertilizer. In some aspects, one or more of the ingredients mixed can be heated during mixing or pre-heated before mixing. In some instances, the ingredients are heated to room temperature or up to 90° C. or more. If additional ingredients, including an additional fertilizer, are included, the additional ingredients can be added at any time in the production of the acidic fertilizer and/or can be added after the acidic fertilizer is formed.

In some aspects, the method (300) can further include drying the wet granulated mixture (301) to form a dry granulated mixture containing the acidic fertilizer granules (302). In some aspects, the drying process can include exposure of the wet granulated mixture (301) to ambient air, heated sweep gas, unheated sweep gas, heat, or any combinations thereof. In some aspects, the dried acidic fertilizer granule can have a moisture content of less than 2.0 wt. %, less than 1.5 wt. %, or less than 1 wt. %.

The method (300) can include optionally coating the acidic fertilizer granules (302) with one or more coating materials, such as a coating that contains water, one or more solubilizing agent(s), one or more binders, and/or one or more anticaking agents, to form a coated fertilizer granules (303). The one or more of water, one or more solubilizing agent(s), one or more binders, and/or one or more anticaking agents can be applied to the acidic fertilizer granule by a variety of methods, such as spraying, pouring, mixing, blending, etc. A fluid bed sprayer or coater, a liquid spray mixer, a rotating drum or pan, spray coating at discharge point, a paddle mixer, etc. can be used.

If more than one coating layer is desired, the acidic fertilizer granule can then be coated with a second, third, fourth, or more layers of one or more coating materials, such as coatings that contain water, one or more solubilizing agent(s), one or more binders, and/or one or more anticaking agents before or after the first coating dries on the core (not shown). For each layer, the amount of time used to apply the coating can be an amount sufficient to ensure that a substantially even layer is formed on the core and/or formed on the subsequent layer. In some instances, the application times can include 5 minutes, 10 minutes, 30 minutes, 1, hour, 2 hours, 3 hours, 4 hours, 5 hours, or more or any range therein (e.g., 5 minutes to 5 hours, 5 minutes to 1 hour, etc.). In some instances, the ingredients are heated to room temperature or up to 90° C. or more.

The total amount of acid added, e.g. to the reactor and/or the granulator, can be sufficient to provide 2 wt. % to 40 wt. % of the inorganic acid in the acidic fertilizer granule, and/or maintain a pH of 4 or lower of the nitrogen-phosphorus paste and/or nitrogen-phosphorus-potassium paste. In some aspects, one or more inorganic acids can be used, and acids other than sulfuric acid can be used. The acid(s) can be added at one or in multiple steps in the method of making the acidic fertilizer.

In some aspects, the acidic fertilizer granule (302) and/or the coated acidic fertilizer granule (303) can be combined additional fertilizers to form a blended or compounded fertilizer. Combining can be performed by any type of blending or mixing apparatus generally available in the art (e.g., WJ-700, WJ-900, or WJ-1000 Mixing Machines from Whirlston Machinery (Zhengzhou, China)). Once combined, the fertilizer blend can be stored for future use or sale.

Alternatively, the acidic fertilizer granules can be produced by a method including grinding readily available non-acidic fertilizer granules (e.g. N, NP, NPK, NPKS, NPKCl, NPKSCl, etc.) into powder, mixing the powder with concentrated inorganic acid solution or inorganic acid particulate to form a mixture, and producing the acidic fertilizer granules using the mixture in a granulation unit. Additional ingredients in addition to the non-acidic fertilizer granules and/or the inorganic acid can used (e.g. added before, during, and/or after inorganic acid addition) to provide acidic fertilizer granules containing nitrogen, phosphorus, potassium, sulfur and chlorine. In some aspects, the inorganic acid provides at least a portion of chlorine and/or sulfur in the acidic fertilizer granules. In some aspects, the non-acidic fertilizer provides at least a portion of chlorine and/or sulfur in the acidic fertilizer granules.

The acidic fertilizer granule can be produced in a batch or continuous process. In some instances, the acidic fertilizer granule is produced on an industrial scale. In some instances, the acidic fertilizer granule is produced at 1 kg/hour or less, or up to 10,000 kg/hour or more.

### C. Method of Fertigation Using the Acidic Fertilizer Granule

With reference to FIG. 4, a non-limiting method (400) of fertigation using the acidic fertilizer granule can include combining the acidic fertilizer granule with water to form a fertigation solution having a pH less than 4 (401). In some aspects, optionally, the method (400) can include combining fertigation solution with additional water to form a fertilizer solution (402). In some aspects, the method (400) can include applying (403) the fertigation solution or the fertilizer solution to a crop. In some aspects, the applying (403) can include adding the fertigation solution or the fertilization solution to an irrigation system and applying the fertigation solution or the fertilization solution to a soil and/or a plant via irrigation.

Non-limiting examples of plants that can benefit from the fertilizer of the present invention include vines, trees, shrubs, stalked plants, ferns, etc. The plants may include orchard crops, ornamental plants, food crops, timber, and harvested plants, etc., such as, for example, palm, coconut, rice, wheat, corn, barley, oats, soybeans, tobacco, tea, and/or canola. The plants may include Gymnosperms, Angiosperms, and/or Pteridophytes. The Gymnosperms may include plants from the Araucariaceae, Cupressaceae, Pinaceae, Podocarpaceae, Sciadopitaceae, Taxaceae, Cycadaceae, and Ginkgoaceae families. The Angiosperms may include plants from the Aceraceae, Agavaceae, Anacardiaceae, Annonaceae, Apocynaceae, Aquifoliaceae, Araliaceae, Arecaceae, Asphodelaceae, Asteraceae, Berberidaceae, Betulaceae, Bignoniaceae, Bombacaceae, Boraginaceae, Burseraceae, Buxaceae, Canellaceae, Cannabaceae, Capparidaceae, Caprifoliaceae, Caricaceae, Casuarinaceae, Celastraceae, Cercidiphyllaceae, Chrysobalanaceae, Clusiaceae, Combretaceae, Cornaceae, Cyrillaceae, Davidsoniaceae, Ebenaceae, Elaeagnaceae, Ericaceae, Euphorbiaceae, Fabaceae, Fagaceae, Grossulariaceae, Hamamelidaceae, Hippocastanaceae, llliciaceae, Juglandaceae, Lauraceae, Lecythidaceae, Lythraceae, Magnoliaceae, Malpighiaceae, Malvaceae, Melastomataceae, Meliaceae, Moraceae, Moringaceae, Muntingiaceae, Myoporaceae, Myricaceae, Myrsinaceae, Myrtaceae, Nothofagaceae, Nyctaginaceae, Nyssaceae, Olacaceae, Oleaceae, Oxalidaceae, Pandanaceae, Papaveraceae, Phyllanthaceae, Pittosporaceae, Platanaceae, Poaceae, Polygonaceae, Proteaceae, Punicaceae, Rhamnaceae, Rhizophoraceae, Rosaceae, Rubiaceae, Rutaceae, Salicaceae, Sapindaceae, Sapotaceae, Simaroubaceae, Solanaceae, Staphyleaceae, Sterculiaceae, Strelitziaceae, Styracaceae, Surianaceae, Symplocaceae, Tamaricaceae, Theaceae, Theophrastaceae, Thymelaeaceae, Tiliaceae, Ulmaceae, Verbenaceae, and/or Vitaceae family.

### EXAMPLES

The present invention will be described in greater detail by way of specific examples. The following examples are offered for illustrative purposes only, and are not intended to limit the invention in any manner. Those of skill in the art will readily recognize a variety of noncritical parameters, which can be changed or modified to yield essentially the same results.

### Example 1

### Production of Acidic Fertilizer Granule

Described below are non-limiting examples of production of acidic fertilizer granules. The acidic fertilizer granules were made from NH₃, phosphoric acid, potassium chloride and sulfuric acid. The ammonia, phosphoric acid, potassium chloride, and sulfuric acid, in an amount shown in Table 1, was added to a granulator and were mixed to form a paste containing a mixture of nitrogen, phosphorus, potassium, sulfur, and chlorine. The sulfuric acid was added in form of a 98 wt. % concentration sulfuric acid solution at a feed rate of 145 kg/Mt. The paste was then granulated to produce wet granules. The wet granules were then dried to form NPK+S+Cl, grade acidic fertilizer granules having a NPKSCl weigh ratio of about 19:19:19:3.5:15.

TABLE 1
Ingredients used

| Material | kg/Ton |
|---|---|
| Phosphoric acid | 360 |
| Sulfuric acid | 100 |
| Potassium chloride | 310 |
| Ammonia | 230 |
| Total | 1000 |

### Example 2

### Production of Acidic Fertilizer Granules with Various Compositions

The acidic fertilizer granules can be produced by any means known in the art. A non-limiting example includes, reacting phosphoric acid with ammonia in a reactor to form a paste of nitrogen-phosphorus. The nitrogen-phosphorus paste can be added to a material containing potassium to form a paste of nitrogen-phosphorus-potassium. In some aspects, the material containing potassium can further contain chlorine and/or sulfur. In certain aspects, other additional additives can be then added to the nitrogen-phosphorus paste and/or nitrogen-phosphorus-potassium paste. The additional additives can include, but are not limited to, a secondary nutrient, one or more trace elements, one or more anticaking agents, water, one or more pigments, or any combinations thereof. The nitrogen-phosphorus-potassium paste can be granulated in a granulator (e.g., granulation drum) to produce the acidic fertilizer granules. The sulfur and chlorine can be independently provided to the acidic fertilizer granules from the inorganic acid, the material containing potassium, and/or another source. The sulfur and chlorine can be added before, during, and/or after formation of the paste. The inorganic acid can be added in the reactor before, after, and/or during the reaction between phosphoric acid and ammonia. The inorganic acid can also be added in the granulator before, after, and/or during the granulation of the nitrogen-phosphorus-potassium paste. In some instances, the inorganic acid added in the reactor and/or the granulator can be concentrated sulfuric acid solution, preferably 98 wt. % sulfuric acid.

It is contemplated that based on the amounts of the starting ingredients used in the process, the resulting acidic fertilizer granule can have various N:P:K:S:Cl (nitrogen:phosphorus:potassium:sulfur:chlorine) weight ratios (NPKSCl grades or NPK+S+Cl grades). These various N:P:K:S:Cl ratios (grades) include, but are not limited to about 7:19:12:15:11, about 7:19:12:10:11, about 9:25:7:8:6, about 10:5:10:10:9, about 13:13:13:11:12, about 10:19:10:10:9, about 10:10:20:13:18, about 8:15:8:9:7, about 11:6:17:12:15, about 8:8:23:14:21, about 10:10:10:10:9, about 8:5:26:15:24, about 6:16:6:8:5, about 6:29:6:8:5, about 10:5:15:12:14, about 11.5:11.5:11.5:9.8:10.4, about 18:9:9:9:8, about 8:26:8:9:7, about 12:12:12:10:11, and about 12:12:4:8:4. The resulting acidic fertilizer can also contain additional micronutrients, secondary nutrients, etc.

In some instances, the acidic fertilizer can be produced by adding acid, such as sulfuric acid that adds additional sulfur, to amounts of raw materials for producing fertilizers. It is contemplated that the N:P:K:S:Cl weight ratio (NPKSCl grade or NPK+S+Cl grade) (e.g., phosphoric acid, ammonia, potash, chloride, and/or sulfuric acid) of the starting material used to produce the acidic fertilizer by this method can include: 11:29:19:0:17, 11:29:19:6.8:17, 11:29:19:7:17, 14:38:10:3.6:8, 16:8:16:5.8:14, 28:28:0:0:0, 20:20:20:7.2:18, 15:30:15:5.4:14, 15:15:30:10.8:27, 12:24:12:4.3:11, 17:10:27:9.7:25, 12:12:36:13:33, 15:15:15:5.4:14, 13:5:40:14.4:36, 10:25:10:3.6:9, 10:45:10:3.6:9, 16:8:24:8.6:22, 18:18:18:6.5:16, 28:14:14:5:13, 13:40:13:4.7:12, 19:19:19:6.8:17, 18:46:0:0:0 (grade of DAP), 11:52:0:0:0 (grade of MAP), or 18:18:5:1.8:4, respectively.

1. An acidic fertilizer granule comprising:
1 wt. % to 45 wt. % of nitrogen;
1 wt. % to 45 wt. % of phosphorus;
1 wt. % to 45 wt. % of potassium;
0.1 wt. % to 20 wt. % of sulfur; and
1 wt. % to 45 wt. % of chlorine,
wherein the granule comprises an effective amount of an inorganic acid sufficient to form a solution having a pH of less than 4 when 10 grams of the fertilizer granule(s) is dissolved in 100 ml of water having a pH of 7 before the fertilizer granule(s) is dissolved in the water.

2. The fertilizer granule of claim 1, wherein the inorganic acid is distributed throughout the granule.

3. The fertilizer granule of claim 1, wherein the amount of the inorganic acid in the granule is sufficient to form a solution having a pH of less than 3 when 10 grams of the fertilizer granule(s) is dissolved in 100 ml of water having a pH of 7 before the fertilizer granule is dissolved in the water.

4. The fertilizer granule of claim 1, comprising 2 wt. % or more of the inorganic acid.

5. The fertilizer granule of claim 1, comprising 8 wt. % or more of the inorganic acid.

6. The fertilizer granule of claim 1, wherein the inorganic acid comprises sulfuric acid, hydrochloric acid, nitric acid, or any combinations thereof.

7. The fertilizer granule of claim 6, wherein the inorganic acid comprises sulfuric acid.

8. The fertilizer granule of claim 1, further comprising a secondary nutrient and/or a micronutrient.

9. The fertilizer granule of claim 1, comprising 2 to 40 wt. % of nitrogen, and at least a portion of nitrogen is present as ammonium.

10. The fertilizer granule of claim 1, comprising 2 to 40 wt. % of phosphorus, and at least a portion of phosphorus is present as phosphate.

11. The fertilizer granule of claim 1, comprising 2 to 40 wt. % of potassium, and at least a portion of potassium is present as potassium salt.

12. The fertilizer granule of claim 1, comprising 2 to 40 wt. % of chlorine, and at least a portion of chlorine is present as chloride.

13. The fertilizer granule of claim 1, comprising 0.5 to 15 wt. % of sulfur and at least a portion of sulfur is present as sulfate.

14. The fertilizer granule of claim 1, comprising 17 to 21 wt. % of nitrogen, 17 to 21 wt. % of phosphorus, 17 to 21 wt. % of potassium, 2 to 5 wt. % of sulfur, and 13 to 19 wt. % of chlorine.

15. The fertilizer granule of claim 1, comprising 8 to 12 wt. % of sulfuric acid.

16. The fertilizer granule of claim 1, having moisture content of less than 2 wt. %, or less than 1 wt. %, measured at 50° C.

17. The fertilizer granule of claim 1, comprised in a fertilizer blend comprising the fertilizer granule and an additional fertilizer.

18. A method of making the acidic fertilizer granule of claim 1, comprising:
adding an inorganic acid to a mixture to form an acidified mixture, wherein the acidified mixture comprises nitrogen, phosphorus, potassium, sulfur, and chlorine; and
granulating the acidified mixture.

19. A method of fertigation, the method comprising:
combining the acidic fertilizer granule of claim 1 with water to form a fertigation solution having a pH less than 4;
optionally combining the fertigation solution with additional water to form a fertilizer solution; and
applying the fertigation solution and/or the fertilizer solution to a soil and/or a crop.

20. The method of claim 19, wherein combining the acidic fertilizer granule with the water decreases the pH of the water from a pH of greater than 4 to a pH of less than 4.
